(19) United States
(12) Patent Application Publication
(10) Pub. No.: US 2025/0237779 A1
(43) Pub. Date: Jul. 24, 2025

(54) SYSTEM FOR MANAGING RECORDS AND PREDICTIONS OF THE SUBSURFACE FRACTURE SPACING

(71) Applicant: SAUDI ARABIA OIL COMPANY, Dhahran (SA)

(72) Inventors: Mohammed M. AlFahmi, Dhahran (SA); Muhammad Kamran Qureshi, Dhahran (SA)

(73) Assignee: SAUDI ARABIA OIL COMPANY, Dhahran (SA)

(21) Appl. No.: 18/418,020

(22) Filed: Jan. 19, 2024

(51) Int. Cl. G01V 1/50; G01V 1/46

(52) U.S. Cl. CPC G01V 1/50; G01V 1/46

(57) ABSTRACT

Systems and methods for managing records and predictions of the subsurface fracture spacing are disclosed. The methods may include, using a computer system: obtaining, from a discontinuity database, discontinuity data and geological layering data, filtering the discontinuity data to output a plurality of arrays of fracture spacings, determining, using the plurality of arrays of fracture spacings, a spatial data analysis and a confidence interval, determining, using the spatial data analysis and confidence interval, a fracture cluster spacing, and determining, using the fracture cluster spacing and the confidence interval, a random fracture spacing and a fracture set spacing. The methods may further include determining, using a geomodeling system, a well placement target based, at least partially, upon the random fracture spacing and the fracture set spacing; and drilling, using a drilling system, the well placement target determined by the geomodeling system.

### BACKGROUND

Subsurface fractures affect petrophysical parameters, including those that determine the flow of fluids in a reservoir. Information about fractures comes from a variety of sources and much of it must be manually interpreted. Accordingly, there exists a need for methods and systems to integrate the disparate data sources and determine the spacing of such fractures.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to methods for managing records and predictions of the subsurface fracture spacing. The methods may include, using a computer system: obtaining, from a discontinuity database, discontinuity data and geological layering data, filtering the discontinuity data to output a plurality of arrays of fracture spacings, determining, using the plurality of arrays of fracture spacings, a spatial data analysis and a confidence interval, determining, using the spatial data analysis and confidence interval, a fracture cluster spacing, and determining, using the fracture cluster spacing and the confidence interval, a random fracture spacing and a fracture set spacing. The methods may further include determining, using a geomodeling system, a well placement target based, at least partially, upon the random fracture spacing and the fracture set spacing; and drilling, using a drilling system, the well placement target determined by the geomodeling system.

In general, in one aspect, embodiments disclosed herein relate to a system for managing records and predictions of the subsurface fracture spacing. The system includes a computer system, configured to: obtain, using a discontinuity database, discontinuity data and geological layering data; filter the discontinuity data to output a plurality of arrays of fracture spacings; determine, using the plurality of arrays of fracture spacings, a spatial data analysis and a confidence interval; determine, using the spatial data analysis and confidence interval, a fracture cluster spacing; and determine, using the fracture cluster spacing and the confidence interval, a random fracture spacing and a fracture set spacing. The system further includes a geomodeling system, configured to determine a well placement target based, at least partially, upon the random fracture spacing and the fracture set spacing; and a drilling system, configured to drill the well placement target determined by the geomodeling system.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a subsurface model with fractures and geological layers, in accordance with one or more embodiments.

FIG. 2 shows cross sections of a subsurface model with fractures and geological layers, in accordance with one or more embodiments.

FIG. 3 shows a workflow, in accordance with one or more embodiments.

FIG. 4 shows a flowchart, in accordance with one or more embodiments.

FIG. 5 shows steps in removing other discontinuities from fracture data, in accordance with one or more embodiments.

FIG. 6 shows a flowchart, in accordance with one or more embodiments.

FIG. 7 shows Monte Carlo estimates of confidence intervals, in accordance with one or more embodiments.

FIG. 8 shows a flowchart, in accordance with one ore more embodiments.

FIG. 9 shows a computer system, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

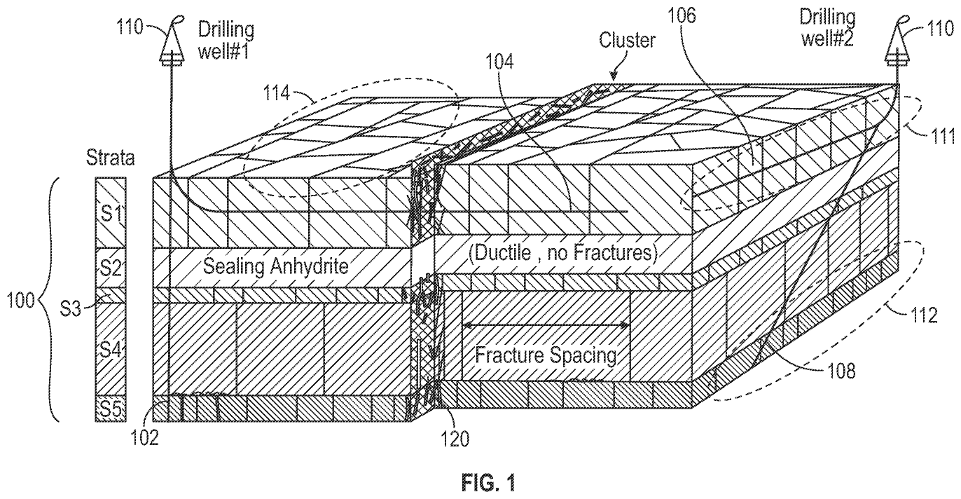

In the following description of FIGS. 1-9, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a fracture spacing” includes reference to one or more of such fracture spacings.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

In one aspect, embodiments disclosed herein relate to an optimized dynamic multi-functional system for data management applied to characterizing naturally occurring fracture spacing in subsurface layered rock formation in aquifers and petroleum reservoirs. The system and methods enable reservoir engineers, simulation engineers, and well completion engineers to quantitatively assess fracture spacing. The methods in this disclosure include integrating stored and streaming information related to fractures intersecting wellbores, and then applying reservoir geological and spatial data analysis to filter, calculate, and model fracture spacing in subterranean layers during wellbore planning, well placement, well completion, and reservoir flow simulation.

For well placement, the methods demonstrate how to either maximize or minimize the probability of intersection of a wellbore with conductive fractures. Regarding well completion, the methods may teach the placement of mechanical tools or the injection of chemical sealants to control fracture fluid flow. For reservoir numerical simulations, the methods show how to incorporate fracture information into dual porosity/dual permeability physical modeling techniques. In some embodiments, the system may be an integral part of hydrocarbon reserve estimation, of how much oil and gas are already displaced or recovered, and for drainage determination for petroleum field development strategy.

In order to incorporate fracture information into any of the above-mentioned applications, the frequency of fractures in a reservoir must be understood. Fractures may be encountered in outcrops; different shapes and sizes of the fractures may be due to variations in stress fields over geological history. Fracture spacing is a measure of the magnitude of fracturing in a rock layer caused by geologic processes. However, it is difficult to measure fracture spacing in subsurface rock formations in petroleum reservoirs due to their inaccessibility. Fracture spacing is normally understood by geologists to be the mean distance between a set of parallel fractures from the 2-D perspective of a geologic map or cross section of outcrops. In essence, the shorter the spacing between fractures, the more fractures there will be in a volume of a rock formation. The spacing of fractures may indicate a dominant geologic setting, a fracture type, or a sampling bias.

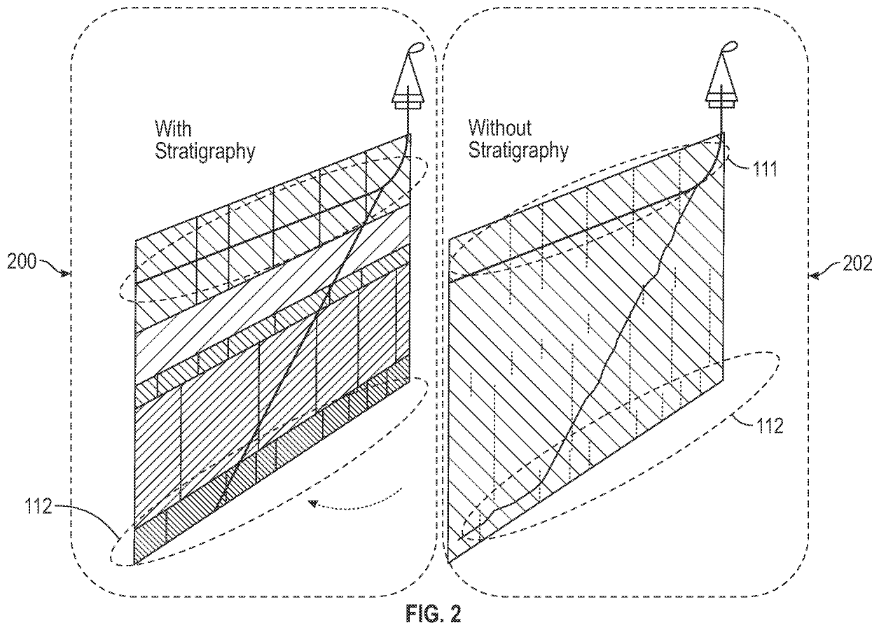

The spacing of fractures may be either regular, random, or clustered. FIGS. 1 and 2 shows an example of a field with each type of fracture spacing. FIG. 1 shows fracture spacing in an earth model of layered and fractured rock. FIG. 2 shows a cross sectional view of the same subsurface fracture model. In both figures, regular spacing may be associated with rock jointing under extensional tectonic stresses and is a rare occurrence. Regular spacing is unlikely to be encountered in subsurface data, e.g., a wellbore with a set of regularly spaced parallel joints in a single layer. Regular spaced fractures (111) may therefore be considered as an end member among a spectrum of spacing configurations.

Randomly spaced fractures (112) may reflect a series of natural fracturing processes and lithological controlling factors in the formation of fracture networks, or else may be produced by sampling biases caused by the wellbore geometry or the wellbore path in the fractured stratigraphy. For example, randomness in spacing may appear if a horizontal wellbore crosses different fracture sets of different spacing in a layer, or if a deviated wellbore traverses different spacing in different rock layers. Randomness, not regularity, is the expected occurrence in nature and the midpoint of the spectrum of possible fracture spacings.

Fracture clustering (120) is the presence of closely-spaced fractures in an area of otherwise widely-spaced fractures along a wellbore path. The presence of a cluster reflects a concentration of stresses (notably shear) that cause rock failure within the intensely-fractured narrow zones. Fracture clustering (120) is treated as the opposite end-member to regular spacing in the spectrum of fracture spacings observable along a wellbore.

When viewed from above, fractures on the surface (114) may be seen as a network with different azimuths organized into roughly parallel sets. In FIG. 1, fractures may be viewed on the two visible side cross sections as lines cutting stratigraphic layers (100), labeled in the figure as S1-S5. FIG. 1 includes 2 drilling wells (110) with 4 sidetrack wellbores (102, 104, 106 and 108). A vertical wellbore (102) intersects all the strata but no fractures; a horizontal wellbore (104) in a single stratum (S1) intersects fractures of semi-regular and cluster nature; a horizontal wellbore (106) in a single stratum (S1) intersects fractures of regular spacing; and a deviated wellbore (108) traverses multiple strata (S1-S5). The deviated wellbore (108) intersects several fractures but it only displays the spacing between two fractures in layer S4. Fracture clustering (120) may be seen in the middle of the earth model around a large shear fracture.

FIG. 2 displays the right side of the earth model shown in FIG. 1 as two separate panels. In the first panel (200), the stratigraphy is superimposed on the fracture network. In the second panel (202), the stratigraphy is missing. This shows the necessity of incorporating the stratigraphy on the model. Without accounting for the stratigraphy it is difficult to determine the fracture spacing. This is because the spacing of a fracture network may be relative to a particular layer that suffered stress at a particular time in the past, independent of later-deposited layers. Thus, any statistical analysis of fracture occurrence should include information regarding in which layer the fractures are observed.

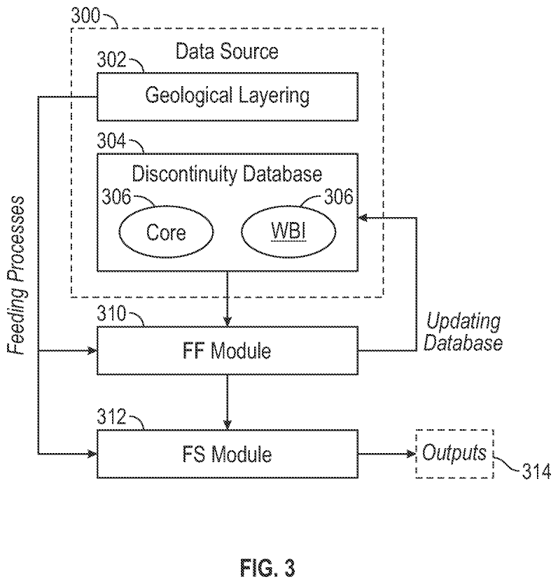

FIG. 3 is a flowchart showing major operations and workflows in accordance with an embodiment. The system starts at the data source step (300) where information regarding geological layering (302) and discontinuities in a subterranean region is received from a legacy discontinuity database (304), from streaming data at a well site, or from both. The information about discontinuities in the discontinuity database (304) may come from either a well core (306) or a wellbore image (WBI) (308). Such data include digital wellbore surveys, locations of discontinuities, mineralization, and orientation (dip and strike degrees). The data source may classify discontinuities according to structural geology or rock mechanic methods known to a person of ordinary skill in the art.

After gathering the data about geological layering (302) and discontinuities, the workflow proceeds first to the Fracture Filtering (FF) Module (310) and then to the Fracture Spacing (FS) Module (312), and finally produces outputs (314) for an operator. The geological layering (302) information is used as input to both the FF Module (310) and FS Module (312) since, as mentioned above, the statistics of fracture occurrence may be relative to different geological layers. The discontinuity database (304) is used as input for the FF Module (310). Furthermore, the FF Module (310) iteratively loops back to and updates the discontinuity database (304).

Information regarding fractures in the discontinuity database may be maintained as georeferenced 3-D geomodels, 3D seismic volumes, or other datasets known to a person of ordinary skill in the art. These other datasets may include maps of well locations and cross sections of stratigraphy. Accordingly, fracture locations may be recorded in the database as an (X, Y, Z) coordinate, or as a measured depth (MD) of the wellbore at which a fracture has observed and recorded. The depth of the fracture is routinely converted to the true vertical subsea (TVDSS), which allows relating fractures to a particular rock layer in a subsurface geomodel.

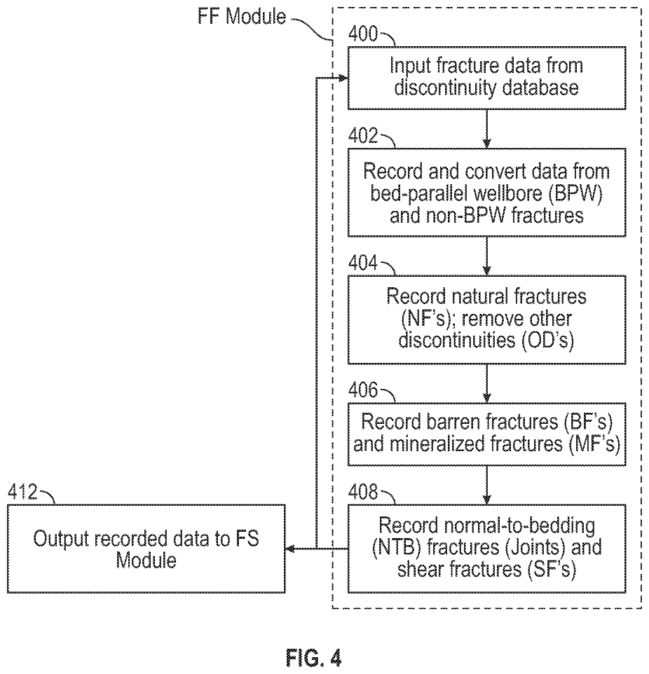

FIG. 4 presents the FF Module (310) in more detail. The FF Module (310) includes several filtering processes that facilitate consistency, ensure replicability, and minimize sampling bias caused by wellbore geometry. Information from the discontinuity database (304) and from known geological layering (302) is input to the FF Module (310) in Step (400).

In Step (402), discontinuities are examined using geometric wellbore information to detect traversed bedding planes. Bedding planes are formed horizontally in sedimentary basins and they remain so except when large-scale folding, faulting, or other tectonic or diagenetic processes causes an inclination in geologic beds. The bed dips are routinely collected with discontinuity data from wellbore images and core samples, where they are observed with bedding plane data.

In Step (402) the dip angles of discontinuities and that of host beds as well as wellbore inclination survey are all used to distinguish between two sources of data, categorized based on wellbore inclinations with respect to the subterranean rock beds. The two data categories are bed-parallel wellbore (BPW) data and non-bed-parallel wellbore data (non-BPW). First, BPW data includes discontinuity data recorded from a single layer in a multi-layered rock, like those from wellbores placed horizontally in a single horizontal stratum in FIG. 1. The non-BPW discontinuity data includes intervals from those wellbores cutting through multiple strata. The non-BPW discontinuity data requires further steps in the data preparations for spacing measurements. Essentially, each interval of the wellbore (regardless its inclination) must be referenced to its equivalent geological layer (302), which is an input from the data sources shown in FIG. 3. The data from BPW and non-BPW are recorded along their wellbore intervals (with starting and ending points), where the interval location and length is defined by the first and last recorded discontinuity along the wellbore in each bed of the stratigraphic layering.

Non-BPW data is normalized to be equivalent to the BPW data for later spacing measurements along beds. Therefore, non-BPW data is converted using trigonometric relationships (viz., the Pythagorean theorem) to the shortest line distance, projected to be parallel to the host bedding plane for each geologic layer using four depth values (MD or TVDSS). The conversion of data also includes removing non-fractured intervals such as the anhydrite layer in FIG. 1. The conversion means that the data of a wellbore are divided into the number of traversed layers with data. It works as follows: The first two values are the entry and exit depth locations for each layer (or, equivalently, the layer top and bottom depths), obtained from the geological layering information provided at the data source in FIG. 3. The next two values used for conversion are the first and last depth values for the fractures encountered in a particular layer. The spacing between fractures for a layer is modified if the wellbore path re-enters the same layer, using the four depth values defined above.

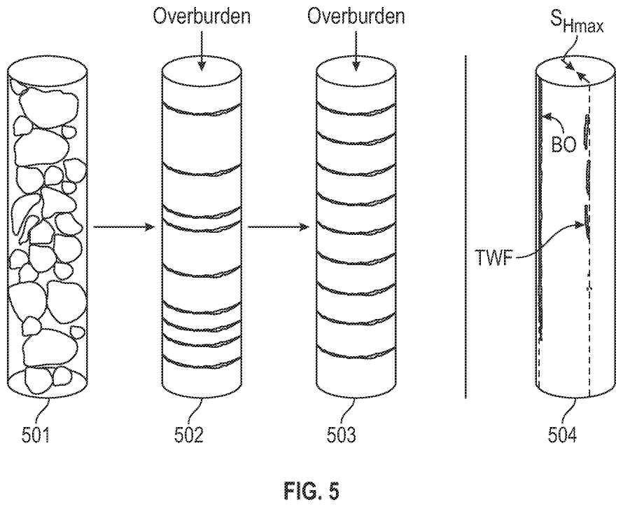

In Step (404), after receiving and normalizing the discontinuity data, the FF Module (310) categorizes and labels discontinuities as either natural fractures (NF) or other discontinuities (OD). The categorization and labeling of natural fractures is based on identifying the following interrelated geometrical components in the discontinuity data: (1) rock strata, (2) wellbore, (3) fractures, and (4) data type (i.e., drill core versus hole image). The OD's in the data may be, but are not limited to, one of the following types: 1) stylolite, 2) non-physical data breaks (artifacts) in wellbore images, 3) core damage, 4) in situ stress-induced breaks, 5) rock splitting along bedding planes, and 6) unidentified features. Stylolite is easily recognized from black serrated surfaces within limestone due to compression and mineral removal by pressure dissolution. Image artifacts and gaps in data may arise from either data collection errors or processing errors. Other information used to distinguish between NF's and OD's includes digital wellbore survey data and wellbore trajectories, which may be vertical (V), deviated (D), or horizontal (H) with respect to the drilled rock strata (as seen in FIG. 1). Furthermore, information regarding the present-day stress field, as well as lithological/stratigraphic properties of the subsurface formations, may also be used. The categorization process for OD's in Step (402) is presented in more detail in FIG. 5, below. The labeled NF data are recorded in an output file and also passed along to Step (406) of the flowchart.

Step (406) takes the NF's and records both barren fractures (BF's) and mineralized fractures (MF's). Examples of MF's are calcite veins. Visual geologic inspection may be used for the filtering process in Step (404), but automated techniques may be used in place of visual geologic inspection. Such techniques may include, but are not limited to, machine learning and artificial intelligence techniques. Step (406) records both the BF's and MF's in output data files. The BF's are sent as input to Step (408).

Step (408) uses fracture dip angle data (of both fractures and geological layers) to distinguish joints (normal-to-bedding (NTB) barren fractures in the range of 75-90 degrees from the bedding planes) from inclined fractures, denoted here as “shear fractures” (SF's). Data used to perform this step include the fracture dip (FD), i.e., the angle between the fracture plane and the bedding plane. FD measures the “true dip,” i.e., the steepest angle of an inclined plane. FD may be obtained as a by-product of interpreting fractures from wellbore images using standard techniques known to a person of ordinary skill in the art. FD may also be obtained from tool orientation information and software applications applied to data in the discontinuity database. Step (408) records the joints (FJ's) and shear fractures (SF's).

After Step (408), the recorded data is sent back to discontinuity database to update it in the case that the data was received in real time. The flowchart also proceeds to Step (412), where the recorded data files are sent to the FS Module (312).

The flowchart in FIG. 4 produces five (5) output files to be subsequently used to predict fracture spacing in the subsurface. Each output is in the form of an array of data values that represent fracture spacing. Each fracture spacing value in each array requires 2 fracture location values to produce it, since each spacing value is the distance between two fractures. In the case of streaming data, the FS Module (312) preserves the spatial location of a first fracture until another fracture is encountered in order to produce a spacing. This enables a dynamic inclusion/exclusion of data points; the module clears the interval length along well path for the traversed geological layers that have a single fracture or none.

Output files are produced at each of Steps 402, 404, 406, and 408. The data recorded at Step 406 is a subset of the data examined at Step 404. Similarly, the data recorded at Step 408 is a subset of the data examined at Step 406.

FIG. 5 presents, visually, the various steps used to remove of OD's in Step (404) from FIG. 4. Step (501) removes intervals of core damage from the data; the damage here may be in the form of crumbled rock caused by the drilling process or else by a core lab's handling of fragile rock. Step (502), using bed dips, core orientation, and lithofacies identification, removes core fractures that are indicative of bed splitting. For example, if a core is acquired vertically from flat bedded carbonates, the angle of intersection is normal (90 degrees) and a cutoff dip angle (i.e., 10 degrees) may be used to automate the process of filtering all core splits along bedding planes. This accounts for some deviations of either the core from the vertical, or else the bedding planes from the horizontal.

The next steps are used to remove in-situ stress-induced breaks observed in the core and along the walls of wellbores that occurred during or after drilling. Step (503) removes the effect of “core disking,” which exhibits fractures with constant spacing along an interval of hard non-naturally-fractured, non-stratified rock. This effect develops during the unloading of the axial (vertical) overburden stress. Step (504) removes breakouts (BOs) and tensile-wall fractures (TWF) from wellbore images based on their geomatical aspect with respect to the wellbore axis and the maximum horizontal principal stress (S_{Hmax}). BO and TWF are known to develop geometrically within planes parallel to the wellbore axis, which in the case of a vertical wellbore are vertical fractures in a vertical hole. While TWF develops with planes (azimuths) parallel to the S_{Hmax} in the region, BO develop as the wellbore is elongated (oval-shaped) at 90 degrees from the S_{Hmax}.

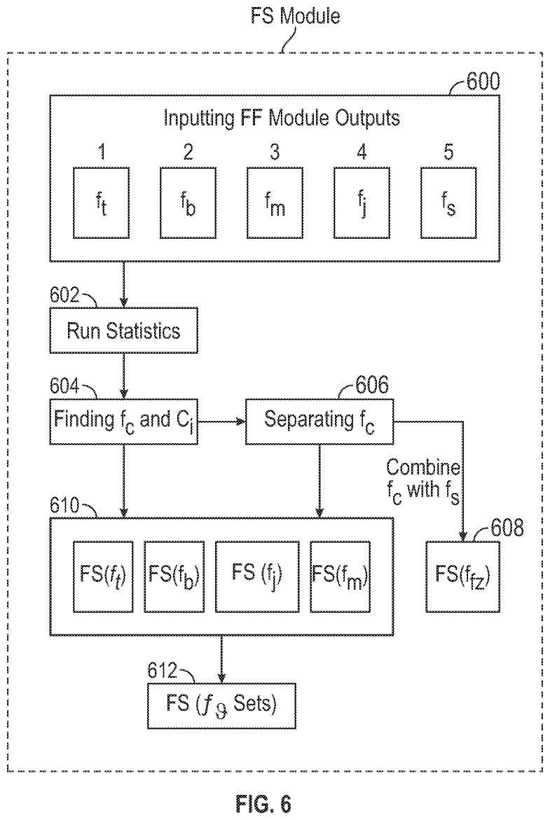

FIG. 6 presents the workflow of the FS Module (312), which determines a spatial data analysis of the data obtained in the FF Module (310). A confidence interval is also determined below in addition to the spatial data analysis. In Step (600), five files, each containing one of the output data types from the FF Module (310), are input to the FS Module (312).

Output 1 is obtained at Step 404 and includes NF data from core and wellbore images. Output 1 is a data array that may be denoted fₜ, the total fracture spacing data obtained from cores and WBI's. fₜ may be identified as one of the following: a rock joint (FJ), a mineralized fracture (vein) (MF), a barren fracture (FB), or a shear fracture (SF). fₜ contains all the fracture data except the OD's.

In more detail, the total fracture spacing data, fₜ, contains information about the general arrangement of natural fractures along some data domain (X₀, Xₙ), such as in an imaged or cored section of a wellbore regardless of its trajectory. fₜ contains similar information to that of a common density log in software applications, except that it is corrected in Step (402) to be representative to the host layers (instead of over a sampling window of, e.g., 2 or 3 feet width). The data in fₜ helps a user comprehend the degree of deformation across regions such as between sedimentary basins, anticlinal structures, and depth terrains. It also helps the user to identify clusters from the general distribution of fractures.

Output 2 is determined in Step (406) and is the result of filtering to find and label barren fractures (BF's). Output 2 is a data array that may be denoted f_{b}, the BF spacing data. f_{b} represents all the NF data except MF's. The barren fracture spacing data, f_{b}, contains information about the degree of the rock relative permeability, deformation, and diagenesis in a sampled formation. BF's have no mineralized content; fracture space has been left unfilled.

Output 3 comes from Step (406) and records all MF's. Output 3 is a data array that may be denoted fₘ, and represents the MF fracture spacing data. The mineralized fracture spacing data, fₘ, contains information about paleo cementation, fluid circulation and chemical diagenesis. This is because these fractures require paleo fluids, high-pressure deformation, and/or chemical reactions to form. MF are considered closed for fluid flow in the subsurface and therefore call for hydrofracking or acid treatment to make the rock permeable.

Output 4 is determined in Step (408) and results from further filtering the BF's to find fracture joints (FJ), or the normal-to-bedding (NTB) fractures. Output 4 is a data array that may be denoted fⱼ, containing the FJ spacing data. The joint spacing data, fⱼ, captures information regarding tensile brittle rock fracturing, thus giving a measure of rock jointing, the predominant form of fracturing in the earth's crust.

Output 5 comes from Step (408) and includes all SF's. Output 5 is a data array that may be denoted fₛ, and includes the SF spacing data. The SF spacing data, fₛ, contains information about the shearing tectonic environment.

Other generated spacing datasets are presented in FIG. 6 and will be defined below: f_{c} (the cluster spacing data), fᵣ (the random fracture spacing data after removing f_{c}), f_{fz} (the fault zone spacing data), and f_{θ} (the fracture set spacing data, defined by the fracture strike degrees).

The output files (1-5) are already prepared along data intervals (X₁, Xₙ) for obtaining statistics of spacings at Step (602). In Step (602), several standard descriptive statistical methods can be used on the five output files to derive numerical characterization of fracture spacings. Examples include frequency distributions, cumulative distributions, Fourier analysis, coefficient of variation, interval counting, fractal theory, and correlation integral.

The statistics and graphical display (where fractures are shown as sticks along lines) are expected to show certain spatial arrangements that can be qualitatively denoted as either of random, clustered, or of regular nature. But the numerical characterization is the means by which such categories are obtained for many phenomena along 1-D space or time domains of seismic images. For example, a perfectly random distribution of events along a line follows a 1-D Poisson distribution, as the spacing between neighboring events can be characterized by a negative exponential distribution with a mathematical mean equaling the standard deviation. Conversely, the periodic regular distribution can be characterized by a symmetrical normal distribution, as the mean is well defined (with a similar value for each spacing), and with a small standard deviation. Falling in between the two extremes is when events show spacing distributions with intermediate skewness, such as gamma or log-normal distribution.

In Step (604), clusters in fracture spacing are to be categorized. The clusters of 1-D sequence data are categorized using a method following “non-parametric statistical methods,” because the data cannot fit parametric statistical distributions (e.g., the normal or exponential distributions). A correlation method (e.g., Spearman's/Pearson's coefficient) is used in Step (604) to determine the correlation between two variables (e.g., mean, standard deviation, etc.) with data sorting along an interval-scale, from the smaller to the larger value, and then each value is replaced with an integer for its position in the sequence.

A variation coefficient, Cy, is used in Step (604) as a determinant of fracture spacing categorization, as Cy distinguishes regular spacing and clustering from random sequences in the analysis of 1D (time and space) series data. The variation coefficient, Cᵥ, may be determined from the mean of fracture spacing values μ, and the standard deviation, σ, via the following equation

$${C}_{v} = \frac{σ}{μ} \qquad Eq . l$$

The standard deviation, σ, of an array, f, is determined by the following equation:

$$σ = {( {\sum }_{n = 1}^{N} ( \frac{{( {f}_{i} - μ )}^{2}}{N - 1} ) )}^{1 / 2} \qquad Eq . 2$$

with fᵢ being the i-th element of the spacing array f, and μ being the mean of the array f. In Eq.2, Bessel's correction is inserted in the denominator as (N−1) in place of N to indicate that the data is only a subsample of an entire population of fractures, N.

The variation coefficient determines the fracture spacing in each category, i.e., whether they are randomly distributed, regularly distributed, or clustered: For randomly distributed fracture spacings along a line, σ≈μ and Cᵥ≈1. For regularly spaced fractures, σ<ρ and Cᵥ<1. For clustered fractures, σ>μ and Cᵥ>1.

Depending on the fracturing nature, some clusters, if they exist, are harder to be identified than others from fₑ in Step (604), due to limitations in the sampling methods (wellbore images and core). Further techniques of 1-D spatial analysis and numerical simulation are therefore employed to get more rigorous results on data arrays. Among these techniques are the correlation integral and Monte Carlo Simulation for obtaining data confidence intervals, Cᵢ (discussed below). In general, it is known that long wellbores are better than shorter ones for determining Cᵥ spacing measurements due to the larger data set from which to draw statistics. The output fₜ is used to determine initial confidence intervals and to further identify beds within the formation for confidence interval calculations.

The fracture cluster spacing data, f_{c}, may be obtained at Step (604) through two procedures: placing cutoffs for the standard deviation, s, of fracture spacing values for a particular array of data, and then obtaining a confidence interval, Cᵢ, using the Monte Carlo method of Step (604). The cutoffs of s are obtained from the relations that σ≈μ for randomly distributed fracture spacings along a line, and Cᵥ≈1. This approximation is used in the process of calculating a confidence interval Cᵢ (Step (604)) as a crossover, by which data of regular spacing is separated from spacing data that is randomly distributed.

In Step (606), the intervals of f_{c} are separated from the data arrays, first from fₜ and then from subsequent data files to output fᵣ, the fracture spacing of random fracture spacing for the five files. Subsequently, in Step (608), the FS Module combines data spacings of f_{c} with that of fₛ to output the fracture spacing of f_{fz} (fracture spacing of fault zones).

Upon subtracting the intervals of clusters, f_{c}, the FS Module (312) redefines the spatial domains of the beginning and ending of the remaining random fractures, fᵣ. It is generated because removing the cluster from the interval leaves a big vacuum that reduces the fracture spacing for subsequent calculations.

In Step (610), the FS Module outputs the fracture spacing of the outputs fₜ, f_{b}, fⱼ, and fₘ. In Step (612), the FS Module divides random fractures into fracture sets, f_{θ}, according to their azimuthal degrees (called fractures strikes). Identifying fracture sets follows standard techniques such as Fisher or Kamb contours on stereonets and applies the standard Terzaghi correction to correct the bias on spacing of parallel fracture sets caused by non-normal scanlines (or wellbores).

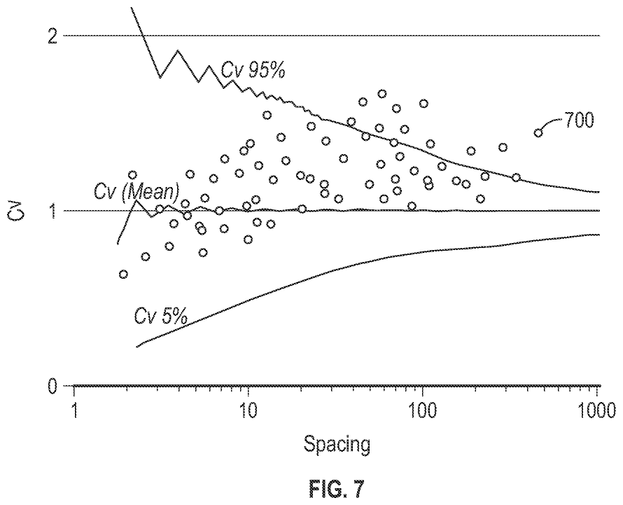

FIG. 7 shows an example of a Monte Carlo Simulation on fracture spacing data. The Monte Carlo simulation starts with random values to produce probability models that fit scattered input data (700) such as Cᵥ versus number of spacings. Monte Carlo simulations for 1D spatial or time-series data typically output a cloud of curves of different degrees of correlations, which help the user extract cutoffs such as, e.g., 95% as an upper bound and 5% as lower bound. The upper cutoffs can also be placed by the user, depending on the data. For example, the user may choose 1.1 or 0.09 for the simulated variable (Cᵥ). The user may also identify the curve departure from such cutoffs of random arrangement toward clusters and regular spacings after identifying a rigorous correlation interval for the data. In Step (604), this identification of clusters is linked with the estimation of a confidence intervals, Cᵢ. A confidence interval is referenced to a probability value; the true value of the parameter has that probability of being within the confidence interval.

The techniques refine, via modeling, the user measures for the data intervals that display f_{c} from the intervals of random fᵣ spacings. By honoring the distances between each individual fracture and the sum in a sequence of an array, these techniques give robust results with regard to the distribution of random fractures across terrains, independent of sampling sizes.

FIG. 7 presents the output of the Monte Carlo simulations of the variation coefficient. The confidence interval becomes more narrow as the number of samples increases (towards the right end of the graph), which is to be expected. The variation coefficient converges to 1 as the sample size increases, thus implying that the fracture spacing of the sample used to produce this particular graph is random.

Monte Carlo simulations show that the correlations are weak for small number of samples (a few data points) but, as the number of data increases, the curve eventually converges upon a clear value for the variable being estimated. FIG. 7 uses a log scale along the x-axis so the to more easily fit a model to the data allow for the application of the statistical methods defined above.

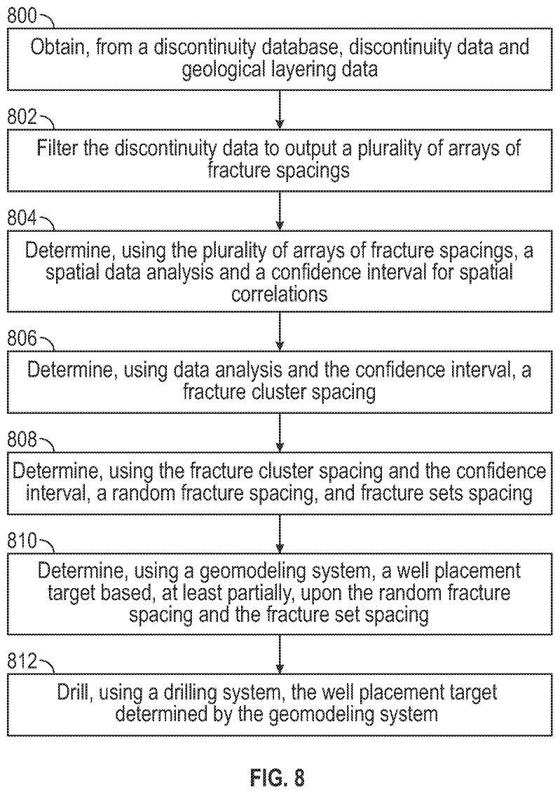

FIG. 8 presents a workflow for the methods presented above. In Step (800), discontinuity data and geological layering data are obtained from a discontinuity database. The discontinuity database contains data from cores as well as WBI's. In Step (802), the data from the discontinuity database is filtered to output a plurality of arrays of fracture spacings. There arrays include the total fracture spacing data obtained from cores and WBI's, the BF spacing data, the NTB BF spacing data from BPW's, the NTB spacing data from all wellbores, the SF spacing data, and the MF fracture spacing data. As part of the creation of these arrays, non-bed-parallel wellbore fractures are referenced to geological layers. Also as part of this Step, (non-natural) discontinuities are removed from the discontinuity data. These (non-natural) discontinuities may include stylolites, non-physical data breaks in wellbore images, core damage, in situ stress-induced breaks, and rock splitting along bedding planes. The discontinuity database comprises core data and WBI data. The discontinuity database is updated with the plurality of arrays of fracture spacings. In Step (804), The plurality of arrays of fracture spacings are used to determine a spatial data analysis and a confidence interval. A variation coefficient is determined as part of this process to indicate the category (i.e., randomly spaced, regularly spaced, or clustered) of fracture spacings that are observed in an array. The confidence interval is also determined through a Monte Carlo method as part of this Step. In Step (806), the spatial data analysis and the confidence intervals are used to determine a fracture cluster spacing. In Step (808), the fracture cluster spacing and the confidence interval are used to determine a random fracture spacing and a fracture set spacing. In Step (810), a geomodelling system is used to determine a well placement target based on the random fracture spacing and the fracture set spacing. Finally, in Step (812), a drilling system is used to drill the well placement target that was determined by the geomodelling system.

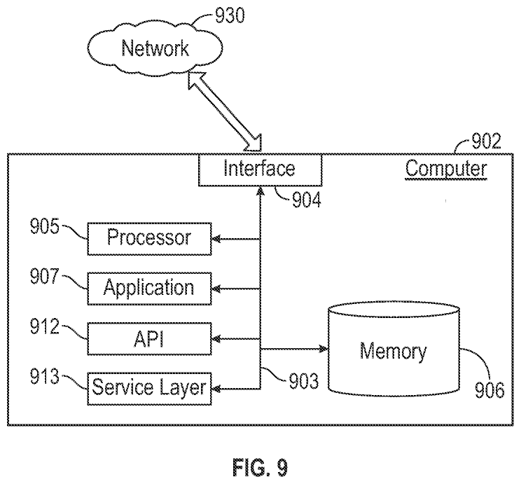

FIG. 9 depicts a block diagram of computer systems (902) used to provide computational functionalities associated with described algorithms, methods, functions, processes, flows, and procedures as described in this disclosure, according to one or more embodiments. The illustrated computer (902) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (902) may include an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component (or a combination of roles) of a computer system for performing the subject matter described in the instant disclosure. The illustrated computer (902) is communicably coupled with a network (930). In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) can receive requests over network (930) from a client application (for example, executing on another computer (902)) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913)). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer. Software services, such as those provided by the service layer (913), provide reusable, defined business functionalities through a defined interface. For example, the interface may be software written in JAVA, C++, or other suitable language providing data in extensible markup language (XML) format or another suitable format. While illustrated as an integrated component of the computer (902), alternative implementations may illustrate the API (912) or the service layer (913) as stand-alone components in relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that can be connected to the network (930). For example, memory (906) can be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, application (907) can serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) can be external to the computer (902).

There may be any number of computers (902) associated with, or external to, a computer system containing computer (902), wherein each computer (902) communicates over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

What is claimed:

1. A method, comprising:
using a computer system:
obtaining, from a discontinuity database, discontinuity data and geological layering data,
filtering the discontinuity data to output a plurality of arrays of fracture spacings, determining, using the plurality of arrays of fracture spacings, a spatial data analysis and a confidence interval,
determining, using the spatial data analysis and confidence interval, a fracture cluster spacing, and
determining, using the fracture cluster spacing and the confidence interval, a random fracture spacing and a fracture set spacing;
determining, using a geomodeling system, a well placement target based, at least partially, upon the random fracture spacing and the fracture set spacing; and
drilling, using a drilling system, the well placement target determined by the geomodeling system.

2. The method of claim 1, further comprising removing other discontinuities from the discontinuity data.

3. The method of claim 1, wherein the discontinuity database further comprises core and WBI data.

4. The method of claim 1, wherein the confidence interval is determined by a Monte Carlo method.

5. The method of claim 1, wherein a variation coefficient determines a fracture spacing category.

6. The method of claim 1, wherein other discontinuities may include one or more of the following list: stylolites, non-physical data breaks in wellbore images, core damage, in situ stress-induced breaks, and rock splitting along bedding planes.

7. The method of claim 1, wherein the plurality of arrays of fracture spacings may include one or more of the following list: mineral fracture spacing, barren fracture spacing, shear fracture spacing, and normal-to-bedding fracture spacing.

8. The method of claim 7, wherein the normal-to-bedding fracture spacing may refer to either bed-parallel wellbore fractures or non-bed-parallel wellbore fractures.

9. The method of claim 8, wherein the non-bed-parallel wellbore fractures are referenced to the geological layering data.

10. The method of claim 1, wherein the discontinuity database is updated with the plurality of arrays of fracture spacings.

11. A system, comprising:
a computer system, configured to:
obtain, using a discontinuity database, discontinuity data and geological layering data,
filter the discontinuity data to output a plurality of arrays of fracture spacings, determine, using the plurality of arrays of fracture spacings, a spatial data analysis and a confidence interval,
determine, using the spatial data analysis and confidence interval, a fracture cluster spacing, and
determine, using the fracture cluster spacing and the confidence interval, a random fracture spacing and a fracture set spacing;
a geomodeling system, configured to determine a well placement target based, at least partially, upon the random fracture spacing and the fracture set spacing; and
a drilling system, configured to drill the well placement target determined by the geomodeling system.

12. The system of claim 11, further comprising removing other discontinuities from the discontinuity data.

13. The system of claim 11, wherein the discontinuity database further comprises core and WBI data.

14. The system of claim 11, wherein the confidence interval is determined by a Monte Carlo method.

15. The system of claim 11, wherein a variation coefficient determines a fracture spacing category.

16. The system of claim 11, wherein other discontinuities may include one or more of the following list: stylolites, non-physical data breaks in wellbore images, core damage, in situ stress-induced breaks, and rock splitting along bedding planes.

17. The system of claim 11, wherein the plurality of arrays of fracture spacings may include one or more of the following list: mineral fracture spacing, barren fracture spacing, shear fracture spacing, and normal-to-bedding fracture spacing.

18. The system of claim 17, wherein the normal-to-bedding fracture spacing may refer to either bed-parallel wellbore fractures or non-bed-parallel wellbore fractures.

19. The system of claim 18, wherein the non-bed-parallel wellbore fractures are referenced to the geological layering data.

20. The system of claim 11, wherein the discontinuity database is updated with the plurality of arrays of fracture spacings.
